(19) United States
(12) Patent Application Publication
(10) Pub. No.: US 2021/0374687 A1
(43) Pub. Date: Dec. 2, 2021

(54) SYSTEMS AND METHODS FOR ADAPTIVE PREVENTATIVE MAINTENANCE IN LIQUID DISPENSING SYSTEMS AND RELATED EQUIPMENT

(71) Applicant: NORDSON CORPORATION, WESTLAKE, OH (US)

(72) Inventors: Kent P. Hand, Gainesville, GA (US); Laurence Saidman, Duluth, GA (US); Peter W. Estelle, Peachtree, GA (US); James Beal, Woodstock, GA (US); Jeremy A. Stone, Duluth, GA (US)

(21) Appl. No.: 16/760,110

(22) PCT Filed: Oct. 26, 2018
(86) PCT No.: PCT/US2018/057754

§ 371 Date: Apr. 29, 2020

Related U.S. Application Data
(60) Provisional application No. 62/579,881, filed on Oct. 31, 2017.

(51) Int. Cl. G06Q 10/00

(52) U.S. Cl. CPC G06Q 10/20

(57) ABSTRACT

Systems and methods for adaptive preventative maintenance are disclosed. In a method to determine a maintenance interval estimate for equipment, a first maintenance interval estimate associated with the equipment is provided. The first maintenance interval estimate is expressed according to a usage metric associated with the equipment. An indication that the equipment has been replaced may be received. An elapsed usage of the equipment in a time period may be determined. The time period may span from a reference time point associated with the first maintenance interval estimate to a later replacement time point associated with the replacement of the equipment. A second maintenance interval estimate may be determined based on the elapsed usage of the equipment. The second maintenance interval estimate may be expressed according to the usage metric associated with the equipment.

### CROSS REFERENCE TO RELATED APPLICATIONS

This application is a U.S. National Stage of PCT International Patent App. No. PCT/US2018/057754, filed Oct. 26, 2018, which claims the benefit of U.S. Provisional Patent App. No. 62/579,881, filed Oct. 31, 2017, the entire disclosures of both of which are hereby incorporated by reference as if set forth in their entireties herein.

### TECHNICAL FIELD

This disclosure relates to equipment maintenance. More particularly, this disclosure relates to adaptive preventative maintenance in liquid dispensing systems and related equipment.

### BACKGROUND

Most manufacturing and other industrial enterprises rely heavily on a wide variety of machines, tools, and other sorts of equipment and those often in vast numbers. For example, a manufacturing plant may operate dozens or even hundreds of pieces of equipment that are generally identical in make and model. Such equipment may operate under strenuous conditions and for long stretches of time, leading to wear and—if not addressed—inevitable breakdown or failure. Unexpected failure may have serious consequences due to lost output from that equipment. Or worse, equipment failure may bring a whole production line to a halt.

Thus there is a need to timely replace or perform maintenance on equipment, preferably during an interval that will cause the least impact to production. While equipment manufacturers and suppliers would prefer to furnish their customers with an accurate schedule for replacement or maintenance intervals, this effort is hampered by the extensive variations in operating conditions of any given type of equipment. For example, one facility may operate their equipment for twenty-two hours a day and under hot and dusty conditions while another facility may operate their equipment, of the same type as the first, for twelve hours a day and under clean and climate-controlled conditions. It would come as no surprise that the former equipment would suffer a diminished lifecycle in relation to the latter equipment. Since the expected life of a given type of equipment may be subject to unknown parameters, the equipment manufacture or supplier is often unable to confidently provide a maintenance or replacement schedule for the equipment.

These and other shortcomings are addressed in the present disclosure.

### SUMMARY

Disclosed herein are systems and methods for adaptive preventative maintenance. In a method to determine a maintenance interval estimate for equipment, a first maintenance interval estimate associated with the equipment may be provided. The first maintenance interval estimate may be expressed according to a usage metric associated with the equipment. An indication that the equipment has been replaced may be received. An elapsed usage of the equipment in a time period may be determined. The time period may span from a reference time point associated with the first maintenance interval estimate to a later replacement time point associated with the replacement of the equipment. A second maintenance interval estimate may be determined based on the elapsed usage of the equipment. The second maintenance interval estimate may be expressed according to the usage metric associated with the equipment.

A reason for the replacement of the equipment may be a further basis in determining the second maintenance interval estimate. When the reason for replacement is preventative, the second maintenance interval estimate may be further based on the difference between the elapsed usage and the first maintenance interval estimate. The second maintenance interval estimate may be further based on a user-defined adjustment parameter.

When the reason for replacement is failure of the equipment, the second maintenance interval estimate may be further based on a user-defined failure parameter. A replacement due to equipment failure may yield a larger adjustment to the second maintenance interval estimate than a preventative replacement. A determined second maintenance interval estimate may be given effect only if the determined second maintenance interval estimate would fall outside a pre-defined percentage range of the first maintenance interval estimate.

If the elapsed usage is greater than the first maintenance interval estimate, a notification may be sent to a user associated with the equipment.

Further iterations of the above-described method may be performed, such as with respect to a second replacement of the equipment and a second elapsed usage of the equipment. In one aspect, the second replacement and elapsed usage of the equipment may be used to determine another third maintenance interval estimate.

Examples of the usage metric may include a time of operation, a number of actuation cycles, a number of operational cycles, a number of objects, and a quantity of material. In another aspect, the usage metric may include an aggregate of at least two of these usage metrics.

In some cases, the equipment may include a fluid dispenser. The replacement of the equipment or the reason for the replacement may be received via a user input.

In another embodiment, a method for effectuating notifications relating to maintenance of equipment is disclosed. The method may include determining that a first elapsed usage of the equipment exceeds a first maintenance interval estimate associated with the equipment. The first maintenance interval estimate may be expressed according to a usage metric associated with the equipment. A first notification may be transmitted to a user and indicate that the first elapsed usage exceeds the first maintenance interval estimate. The elapsed usage may span a first time period beginning at a first time point associated with the first maintenance interval estimate and ending at a second time point associated with the determination that the first elapsed usage of the equipment exceeds the first maintenance interval estimate. A failure to replace the equipment may be determined. A second notification that is associated with the failure to replace the equipment may be transmitted to the user associated with the equipment.

If an equipment replacement is thereafter indicated, a second maintenance interval estimate may be determined based on the elapsed usage from a time point associated with the first maintenance interval estimate to the time point associated with the replacement of the equipment. If the equipment is not replaced, another notification may be transmitted to the user. The interval between this notification and the prior notification may be shorter than the intervals between earlier notifications. Further, the third notification and other subsequent notifications me be transmitted via a different transmission medium than earlier notifications, as well as to different recipient.

### BRIEF DESCRIPTION OF DRAWINGS

The accompanying drawings, which are incorporated in and constitute a part of this specification, illustrate embodiments and together with the description, serve to explain the principles of the methods and systems:

FIG. 1 illustrates a cross-sectional view of a fluid dispenser according to an embodiment of the present disclosure;

FIG. 2 illustrates a data flow diagram according to an embodiment of the present disclosure;

FIG. 3 illustrates a decisional flow diagram according to an embodiment of the present disclosure; and

FIG. 4 illustrates a method flow diagram according to an embodiment of the present disclosure.

### DETAILED DESCRIPTION

The systems and methods of the present disclosure relate to adaptive preventative maintenance, which may be used in the context of liquid dispensing systems and other related equipment. Due to the aforementioned variations in operating conditions, equipment manufacturers and suppliers are usually unable to provide a reliable maintenance and/or replacement schedule. The adaptive preventative maintenance techniques disclosed herein address this problem, among others, by leveraging empirical data collected under actual operating conditions to iteratively refine a maintenance interval estimate.

The maintenance interval estimate may represent a time period after which an operator should replace or perform maintenance on equipment of that type before, within a reasonable confidence level, the equipment fails. The maintenance interval estimate may be determined in each iteration of the process according to an elapsed usage of the equipment between successive replacements or maintenances of the equipment. The elapsed usage may be represented according to one or more usage metrics, such as time of use, number of actuation cycles, or number of dispensing operations. The reason for the equipment replacement may be preventative or a failure of the equipment. This reason may affect the determination of the iteration's adjusted maintenance interval estimate. If the elapsed usage of the equipment exceeds the maintenance interval estimate, this may indicate that the equipment has an undesirable risk of failure. When this occurs, a notification message may be sent to an operator or other responsible party to inform them of such. The operator may thereby address the problematic situation by replacing or performing maintenance on the equipment.

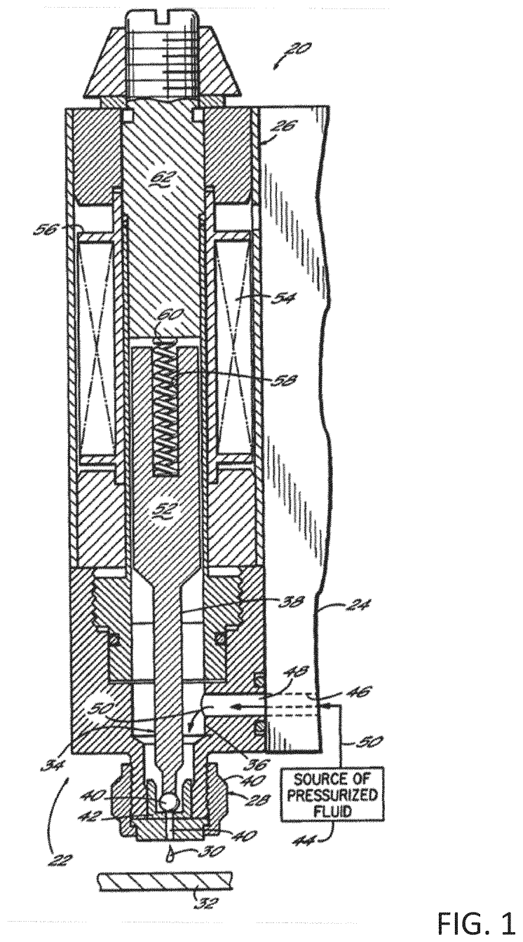

Referring to FIG. 1, an electrically operated fluid dispenser or dispensing gun 20 comprises one or more dispensing modules or valves 22 mounted on a fluid distribution manifold plate 24 in a known manner. The dispensing valve 22 includes a dispenser body 26 and a fluid dispensing nozzle body 28. The dispenser 20 is normally used to dispense high viscosity fluids, for example, a hot melt adhesive, solder flux, thermal grease, etc., but low viscosity fluids may be dispensed by the dispenser 20 or similar dispensers. Furthermore, the dispenser 20 is mounted in a dispensing machine or system (not shown) in a known manner to dispense fluids in discrete amounts, for example, as droplets or dots, but alternatively in continuous beads. As shown in FIG. 1, the dispenser body 26 used in conjunction with the fluid dispensing nozzle body 28 is particularly constructed to dispense fluid 30 onto a substrate 32. Relative motion between the substrate 32 and dispenser 20 is provided in a known manner.

A valve stem 34 is mounted in an interior portion 36 of the dispenser body 26, and the valve stem includes a shaft 38 through the interior portion 36. A ball 40 is mounted to a lower end of the shaft 38 which is shown in FIG. 1 in sealing engagement with a valve seat 42 positioned in the nozzle body 28. Thus, the valve stem 34 and ball reciprocate between open and closed positions with respect to the valve seat 42, thereby operating as a dispensing valve 22. When the valve stem 34 is in the open position, fluid is received from a fluid source 44, through a fluid passage 46 in the manifold 24 and through an inlet passageway 48. The source 44 of hot melt adhesive is normally pressurized. Arrows 50 indicate the flow path of the fluid. An armature 52 is disposed within the interior portion 36 and is coaxially aligned with and, preferably, formed integrally with shaft 38. An electromagnetic coil 54 is disposed about the armature 52. The coil 54 is contained in a housing 56 and connected to a power source (not shown). When supplied with electrical current, the coil 54 generates an electromagnetic field which actuates the valve stem 34 to an open position as will be described below.

A bore 58 extends into the armature 52 to house a return spring 60. The return spring 60 biases the valve stem 34 and, more specifically, the ball 40, to sealingly engage the valve seat 42 in a closed position. The return spring 60 is normally a compression spring which is placed under compression within the bore 58 through engagement with an electromagnetic pole 62. To achieve an open position, the electromagnetic coil 54 must generate a sufficient electromagnetic field between the armature 52 and the pole 62 so as to attract the armature 52 and the pole 62 together. Since the pole 62 cannot move, the armature 52 will move against the force of the spring 60 until it hits the pole 62.

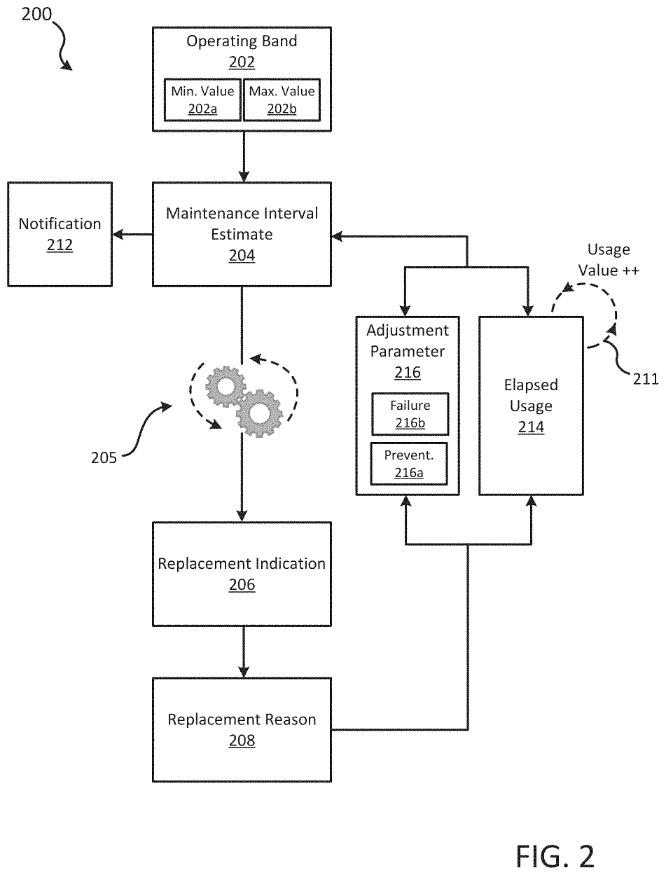

FIG. 2 illustrates a data flow diagram 200 that represents, at least in part, a process of adaptive preventative maintenance according to an embodiment of the present disclosure. By way of introduction, the adaptive preventative maintenance process may estimate a replacement schedule (e.g., a projected life) and/or maintenance schedule for a piece of equipment. The adaptive preventative maintenance process, or portions thereof, may be performed iteratively to determine an increasingly accurate time or other cumulative usage metric at which the equipment should be replaced or maintenance otherwise performed. A first maintenance interval estimate 204, falling within an operating band 202, may be initially determined. When the equipment is subsequently replaced (reflected in a replacement indication 206) and a replacement reason 208 is determined, the maintenance interval estimate 204 is recalculated based at least on the replacement reason 208 and an elapsed usage 214 of the equipment at the time of replacement. The cyclical portions of the process may be repeated to adaptively refine the maintenance interval estimate 204. If at any time the elapsed usage 214 reaches the maintenance interval estimate 204, a notification 212 may be sent to an operator or other personnel to notify them of such.

The adaptive preventative maintenance process may be performed in relation to a wide range of equipment types, including the dispenser 20 shown in FIG. 1, which may be part of a larger dispensing system (not shown in FIG.1). Other non-exhaustive examples to which adaptive preventative maintenance may be applied include hot-melt adhesive dispenser systems (jetting and non-jetting), powder or spray coating systems, extruding systems, conformal coating systems, and other related equipment and/or systems. Other examples include a solenoid, a pump, a dispensing gun, and a heater. Indeed, the adaptive preventative maintenance process may be applied to virtually any equipment that has some measurable (or at least amenable to estimation) usage metric.

The adaptive preventative maintenance process described herein may be applied at various levels of a given system. For example, the adaptive preventative maintenance process may be implemented with respect to a complete system (or multiple systems); a mechanism, module, or assembly having several sub-parts or sub-components; a single part or component; or an even lesser aspect of a system. Taking the dispensing system of which the dispenser 20 of FIG. 1 is a component, as an example, adaptive preventative maintenance process may be directed to the dispensing system as a whole, the dispenser 20 of the dispensing system, the dispensing module/valve 22 of the dispenser 20, or the nozzle body 28 of the dispensing module/valve 22. In some aspects, the adaptive preventative maintenance process may be generally directed to a system but also with due consideration to some sub-portion of the system.

In some embodiments, the adaptive preventative maintenance process may be directed to equipment operating according to one or more parameters. In this case, the equipment may be identified not just by the particular model of equipment, but also by the associated operating parameter. In such an embodiment, equipment of a model operating with one parameter and equipment of the same model but operating with a second different parameter may be considered as two separate “equipment” for the purposes of the process. Operating parameters may include associated material (e.g., the material dispensed by a dispensing gun) or rate of operational cycles (e.g., rate of material dispenses, reciprocation rate of a piston pump or pneumatic pump, rate of solenoid activations, etc.). The particular operating parameter may significantly affect the time interval between equipment replacement. For, example, a pump may perform a particular number of cycles at a high rate. An otherwise identical second pump may perform the same number of cycles but at a lower rate. Despite performing the same number of cycles, the first instance of the pump may require an earlier replacement due to the extra heat caused by the rapid cycles. As another example, variances in temperature or material may likewise affect the replacement intervals of dispensing guns despite an equal number of dispensing cycles.

In some embodiments, adaptive preventative maintenance may be collectively applied to a set of several discrete systems (or portions thereof), which may share similarities in mechanical, operational, and/or environmental characteristics. For example, a manufacturing plant may house an array of generally identical or similar dispensing systems, each operating under the same general environmental conditions, running for approximately the same periods of time each day, and/or according to other parameters. Such parameters may include those described above. In some aspects, a maintenance interval estimate 204 may be determined for each discrete system in the set, which then may be aggregated (e.g., averaged) to further refine an aggregate maintenance interval estimate 204 that then may be applied to each of the systems in the set of systems. In other aspects, the set of systems (e.g., the aforementioned set of dispensing systems) may be considered as a single system for purposes of the adaptive preventative maintenance process.

For ease of reference, the aforementioned aspects of a system, the system itself, or a set of systems shall be referred to herein simply as “equipment,” unless otherwise indicated expressly or by context. Further, it will be understood that “equipment” may refer to multiple instances of the same or similar equipment over multiple iterations of the process. For example, a pump (i.e., the “equipment”) discussed in relation to the adaptive preventative maintenance process may collectively refer to a first pump, which is replaced by a second pump of the same type in a second iteration, which, in turn, is replaced by a third pump of the same type in a third iteration, and so forth. In some aspects, “equipment” may refer to instances of equipment over successive iterations that are generally of the same make, model, etc., but yet have one or more improvements or changes, particularly in comparison to an earlier instance of the equipment. Indeed, one of the advancements observed in the present disclosure is that the maintenance interval estimate 204 (and thus the replacement or maintenance schedule) inherently adapts to these or other changes affecting the equipment. This adaptability is realized, at least in part, by the iterative nature of the process and the use of real-world replacement intervals.

As noted, the example adaptive preventative maintenance process embodied in the data flow diagram 200 may be directed to equipment. One or more usage values (or an aggregate of multiple usage values) of the equipment may be represented by the elapsed usage 214 and expressed in terms of a usage metric. A usage metric represented by the elapsed usage 214 may indicate, for example, an ongoing time interval, including a continuous time interval since the equipment was initially installed or put into use (e.g., the chronological “life,” irrespective of actual use) or an aggregate of time intervals (e.g., the number of hours in which the equipment was actually operating).

As other examples, a usage metric may indicate a number of cycles or discrete operations performed by the equipment, such as the number of reciprocation cycles of a piston pump or solenoid, or the number of individual dispenses performed by a dispensing gun. As yet other examples, a usage metric may describe a quantity of material or a number (or other measure) of objects relating to the operation of the equipment, such as a quantity of fluid passing through a heated fluid conduit or a number of printed circuit boards treated by a conformal coating system. As indicated, a usage metric may refer to an aggregate of several usage metrics. For instance, a usage metric for a heater may be an aggregate of its operating temperature and its accumulated time of operation. Such an aggregate usage metric may be represented as a product of two or more usage metric values or an integral thereof.

The elapsed usage 214 is generally expected to be a monotonically increasing value. As a number of operations, a time interval, a quantity of material processed, or other usage metric increases, the elapsed usage 214 may be likewise incremented or increased. The increment or increase of the elapsed usage 214 is indicated by reference character 211 in FIG. 2. The elapsed usage 214 need not be updated in real-time, but instead may be updated at various regular or irregular intervals or at certain quantitative milestones associated with the usage metric.

At various points in the adaptive preventative maintenance process, the elapsed usage 214 may be reset to a nil or a default starting value. For example, this may occur at the beginning of an iteration of the process or part thereof, such as when the equipment is replaced or when the maintenance interval estimate 204 is thereafter recalculated.

The elapsed usage 214 may be updated by an automated process, such as by an appropriate sensor, counter, or other measurement device incorporated with or otherwise associated with the equipment. These measurement devices may be equipped with radio transmitters to upload the collected usage data to an external computer system. The computer system may store the usage data and/or process the usage data according to at least a portion of the disclosed adaptive preventative maintenance process.

In other instances, the elapsed usage 214 may be collected and/or maintained by a manual process, such as an operator logging the operating time or other usage metric of the equipment. The manual process of maintaining the elapsed usage 214 may be performed via a user interface of a computer application of a computer system. The elapsed usage 214 and/or a historical log of the elapsed usage 214 may be stored on a database or other storage medium of the computer system. As noted, the computer system may perform at least a portion of the adaptive preventative maintenance process using the manual input. Whether by automated or manual process, the elapsed usage 214 may be an estimate of the corresponding usage metric. For instance, a fluid dispensing system may perform tens or hundreds of thousands of separate fluid applications over a day, thus making an exact count impractical.

In some cases, the manual tracking and recordation of the elapsed usage 214, including via user input to a computer system, may be preferred over an automated process that requires sensors and the like to be incorporated in the equipment. The inclusion of sensors or similar devices in equipment may be costly and negatively impact the production cost to the equipment manufacturer. The increased production costs are then passed on to buyers of the equipment. With continuous operation and often under rigorous conditions, many buyers exhaust the useful life of equipment in short order, thus multiplying the additional cost of each piece of equipment due to sensor integration. Hence, equipment manufacturers may be reluctant to integrate sensors or other measuring devices in their equipment for fear of reducing sales of the equipment.

Continuing the description of the data flow diagram 200, an operating band 202 may refer to a range of values of the usage metric represented in the elapsed usage 214. The range of values may include a maintenance interval at which the adaptive preventative maintenance process estimates that the equipment should be replaced or receive maintenance. In addition, the process may communicate a notification 212 to an operator when the elapsed usage 214 reaches the maintenance interval estimate 204. Thus, the operating band 202 may be defined by the range of usage metric values spanning from a minimum value 202a to a maximum value 202b. The minimum value 202a may represent a value of the elapsed usage 214 before which a notification is never communicated to an operator, even if the elapsed usage 214 exceeds the maintenance interval estimate 204. Conversely, the maximum value 202b may represent a value of the elapsed usage 214 after which a notification is always communicated to an operator, even if the elapsed usage 214 has not exceeded the maintenance interval estimate 204. The operating band 202 may be determined by the manufacturer or supplier of the equipment, such as according to the various engineering attributes of the equipment.

The maintenance interval estimate 204 may represent an elapsed usage 214 (e.g., an operating time, a number of operating cycles, etc.) at which the equipment is estimated to require replacement or maintenance (or at least should receive such). As noted, the maintenance interval estimate 204 is constrained by the minimum value 202a and the maximum value 202b of the operating band 202. That is, the relationship may be represented by the following equation.

MI_MIN<MI_EST<MI_MAX

MI_MIN represents the minimum value 202a, MI_MAX represents the maximum value 202b, and MI_EST represents the maintenance interval estimate 204. Such designations shall be used in equations throughout the disclosure. The maintenance interval estimate 204 initially may be a default value at the midway point of the operating band 202, which is represented in the following equation.

$$MI\_EST = \frac{MI\_MIN + MI\_MAX}{2}$$

As will be explained in greater detail herein, the maintenance interval estimate 204 may be recalculated and updated over successive iterations of the adaptive preventative maintenance process. In addition, it will be further explained that, when the elapsed usage 214 reaches the maintenance interval estimate 204, the notification 212 may be communicated to an operator or other personnel.

After the maintenance interval estimate 204 is initially calculated or recalculated to determine a new value (subject to some conditions explained below), the equipment may be operated, or otherwise made use of, in a usual manner until a replacement of the equipment is identified. Such period of operation is signified by the reference character 205 in FIG. 2.

When a replacement of equipment, or component thereof, is detected or determined, the process may determine a replacement indication 206. Said another way, the replacement indication 206 may reflect that the equipment has been replaced. The replacement of the equipment may comprise replacing the current equipment with another instance (e.g., the same make and model) of the equipment. In some cases, the new instance of the equipment may be of the same make and model, but may include some improvements or other minor changes.

The replacement indication 206 may be based on an automated process to determine the replacement. For example, the equipment may include a sensor configured to determine that the equipment has been replaced. As another example, the equipment may be part of a larger system which may likewise recognize that the equipment was replaced. Additionally or alternatively , the replacement indication 206 may be based on a manual process. For example, the operator or other associated personnel may log the replacement, such as via a user interface of a computer application running on a computer system. The replacement indication 206 may be stored in a database associated with the computer system.

It is contemplated that “replacement” of the equipment may exclude instances in which the equipment is merely “changed,” such as switching out the equipment for another type, model, brand, etc. of analogous equipment. A “replacement” of the equipment may be due to some operational status (e.g., the equipment is malfunctioning or experiencing degraded performance) and/or usage metric relating to the equipment, whereas a “change” of equipment may be due to some other reason, such as dissatisfaction with the performance of the initial equipment or a better price of the new equipment of another make, model, brand, etc. In the event of a “change,” the process of adaptive preventative maintenance may be reset since the data of the process for the replaced equipment may be inapplicable to the new equipment.

Although the data flow diagram 200 is presented primarily with regard to replacement of equipment, the same or similar principles may be applied to repair, maintenance without placement, or any combination or sub-combination of the three activities. As used herein, “maintenance” may refer to general upkeep or service of equipment, including activities conducted according to a schedule or set intervals. While maintenance may result in improved equipment performance, it is not responsive to a significant malfunction of the equipment. On the other hand, “repair” may be conducted in reaction to a significant malfunction causing adverse effects to equipment functionality, including complete failure. A repair may bring the equipment back to a functioning state and may be an alternative to replacement.

The process may determine a reason for or cause of the equipment replacement (the replacement reason 208 in FIG. 2). The replacement reason 208 may be determined following the indication that the equipment was replaced. The replacement reason 208 may be a binary value indicating whether the replacement was either a preventative replacement (e.g., the equipment was functional when replaced) or a replacement due to failure (e.g., the equipment was not functional when replaced). It is contemplated that other reasons for replacement may be identified or further delineated and incorporated into the adaptive preventative maintenance process according to the same or similar principles described herein. For example, a replacement for failure of the equipment may be separately classified as a failure of the equipment due to failure of one particular subcomponent or as a failure of the equipment due to failure of another particular subcomponent.

The replacement reason 208 may be indicated by an operator or other personnel. For example, the operator may provide such input via a selection of one of the two replacement reasons presented as radio buttons in a user interface of a computer application. In other instances, the reason for replacement may be indicated via an automated process, such as may occur if the equipment is configured to detect whether it experienced a failure and transmit that to the computer system.

When the equipment replacement occurs (e.g., a time indicated in the replacement indication 206), the elapsed usage 214 at replacement may be recorded. For example, the elapsed usage 214 at replacement may represent the change in a usage value between when the maintenance interval estimate 204 was last determined and the time at which the replacement occurred. As another example, the elapsed usage 214 may represent the change in a usage value between when the equipment was replaced in the previous iteration and when the equipment was replaced in the instant iteration of the process.

A new maintenance interval estimate 204 may be calculated (e.g., the maintenance interval estimate 204 from the previous iteration may be re-calculated) based at least on the prior maintenance interval estimate 204, the replacement reason 208, and/or the elapsed usage 214 at replacement. Based on this empirical evidence reflecting the actual usage conditions unique to the particular installation, the maintenance interval estimate 204 may be adjusted over time towards a value that more accurately represents a time at which that particular equipment should be maintained and/or replaced.

Generally, if the replacement reason 208 indicates a preventative replacement, the current maintenance interval estimate 204 may be adjusted towards the elapsed usage 214 at the time of replacement by a lesser degree than if the replacement reason 208 indicated a replacement due to equipment failure. This difference in the degree of adjustment between a preventative replacement and a replacement due to failure may be beneficial because equipment failures more directly indicate the actual life (in terms of the appropriate usage metric) of the equipment. Whereas in the case of preventative replacement, the hypothetical usage value at which the equipment actually fails is unknown since equipment failure may be imminent at the time of preventative replacement. Yet it is also possible that the failure would not have occurred for a significant period of time (or other increments of appropriate usage metrics).

The determination of the new maintenance interval estimate 204 may be further based on an adjustment parameter 216. The adjustment parameter 216 may be a numeric value that affects how and to what degree the current maintenance interval estimate 204 may be adjusted towards the elapsed usage 214 at the time of replacement. The adjustment parameter 216 may comprise a preventative parameter 216a and/or a failure parameter 216b. The preventative parameter 216a may be used when the replacement reason 208 is preventative and the failure parameter 216b may be used when the replacement reason 208 is failure. Further, the replacement reason 208 may affect the formula or methodology used in calculating the new maintenance interval estimate 204.

In the case of a preventative replacement, the new maintenance interval estimate may be based, at least in part, on a difference between the current maintenance interval estimate 204 and the elapsed usage 214. For example, the new maintenance interval estimate 204 may be calculated according to the following formula:

MI_NEW=MI_EST+K_PRV*(EL_USE−MI_EST)

MI_NEW represents what typically will be the new maintenance interval estimate 204, EL_USE represents the elapsed usage 214 at the time of replacement, and K_PRV represents the preventative parameter 216a. Again, MI_EST represents the current maintenance interval estimate 204 (i.e., the maintenance interval estimate 204 that is being recalculated).

The preventative parameter 216a may affect the degree to which the current maintenance interval estimate 204 is adjusted toward the elapsed usage 214 at the time of replacement. As used in the above equation, the preventative parameter 216a is a value between 0 and 1. At one extreme, if the preventative parameter 216a is 0, the maintenance interval estimate 204 will not undergo any adjustment. That is, the new maintenance interval estimate 204 will be equal to the current maintenance interval estimate 204. At the other extreme, if the preventative parameter 216a is 1, the new maintenance interval estimate 204 will be equal to the elapsed usage 214 , the maximum adjustment possible.

At some intermediate preventative parameter 216a, the maintenance interval estimate 204 will only be adjusted some fraction of the difference between the current maintenance interval estimate 204 and the elapsed usage 214 at the time of replacement. For example, if the preventative parameter 216a is 0.5, the maintenance interval estimate 204 will be adjusted to halfway between the current maintenance interval 204 and the elapsed usage 214. In this example implementation, a higher value will result in a greater adjustment to the maintenance interval estimate 204 and a lower value will result in a lesser adjustment. Assuming that the elapsed usage 214 remains the same or similar over these iterations, the maintenance interval estimate 204 will be within 6.3% of the elapsed usage 214 over four iterations. Again assuming that the elapsed usage 214 remains the same or similar over these iterations, the preventative parameter 216a at 0.63 will result in the maintenance interval estimate 204 being within 5% of the elapsed usage 214 after three iterations.

If the equipment was replaced due to equipment failure, the new maintenance interval estimate 204 may be based on a multiplicative product of the elapsed usage 214 and an operator defined parameter, such as the failure parameter 216b. The failure parameter 216a may be a value less than one, thus the new maintenance interval estimate 204 may be equal to a fraction of the elapsed usage 214. As an example, the new maintenance interval estimate 204 may be calculated according to the following equation:

MI_NEW=K_FLR*EL_USE

K_FLR represents the failure parameter 216b. As already noted, MI_EST represents the current maintenance interval estimate 204, MI_NEW represents the new maintenance interval estimate 204, and EL_USE represents the elapsed usage 214 at replacement.

As may be appreciated, when the equipment is replaced due to failure, the maintenance interval estimate 204 may move towards the elapsed usage 214 at replacement more quickly than is typically the case when the equipment is preventatively replaced. It is perceived that the degree of adjustment that results from the failure parameter 216b is a desirable degree of adjustment when the equipment is replaced due to failure. In some instances, an equipment operator may perform several iterations of the process in which the equipment is purposely operated until failure. While at the cost of the failed equipment, this may allow the operator to more quickly determine a reasonably accurate maintenance interval estimate 204 than would be the case if the process was performed without this purposeful initial intervention.

The preventative parameter 216a and/or the failure parameter 216b may be set by the equipment manufacturer, such as by an engineer of the equipment manufacturer. In other instances, an operator using the equipment may set the preventative parameter 216a and/or the failure parameter 216b. In either case, for example, the parameters may be set to pursue a more aggressive adjustment and, accordingly, set the preventative parameter 216a and/or the failure parameter 216b to higher value(s). Conversely, a more conservative approach may be preferred and thus lower values may be selected for the preventative parameter 216a and/or the failure parameter 216b. The preventative parameter 216a and/or the failure parameter 216b may be adjusted between iterations of the process or may remain constant over multiple iterations.

In some embodiments, the recalculation of the maintenance interval estimate 204 may comprise steps to prevent “drift” in the maintenance interval estimate 204. That is, minor adjustments to the maintenance interval estimate 204 are not given effect. If a potential new maintenance interval estimate 204 is within specified limits relative to the current maintenance interval estimate 204, the current maintenance interval estimate 204 is not adjusted and the following iteration of the process (or portion thereof) proceeds using the current, unadjusted maintenance interval estimate 204. The specified limit determining whether to use the new recalculated maintenance interval estimate 204 may be represented by a percentage value indicating the lowest allowable percent difference between the potential new maintenance interval estimate 204 and the current maintenance interval estimate 204. Whether to adjust the maintenance interval estimate 204 or not may be determined according to the following algorithm.

$$if ( \frac{\vert MI\_NEW + MI\_EST \vert}{MI\_EST} ) \leq ADJ\_LMT then \text{:}$$

$$MI\_NEW = MI\_EST$$

$$else \text{:}$$

$$MI\_NEW = MI\_NEW$$

ADJ_LW represents the lowest permissible relative change, in a percentage value, from the maintenance interval estimate 204 currently in effect to the newly-calculated, but not yet effectuated, maintenance interval estimate 204. For use in the above equation, ADJ_LMT must be expressed in decimal form (e.g., 0.05 instead of 5%). To summarize the above equation, the potential percent change (in decimal form) from the current maintenance interval estimate 204 to the prospective new maintenance interval estimate 204 is calculated by determining the non-negative difference between the two and dividing that difference by the current maintenance interval estimate 204. If that value is greater than the specified permissible change percentage, then the new maintenance interval estimate 204 replaces the current maintenance interval estimate 204 for the following iteration. Yet if that value is less than or equal to the specified permissible change percentage, then the newly-calculated maintenance interval estimate 204 is not given effect and the current maintenance interval estimate 204 is carried forward in the following iteration.

The adjustment of the current maintenance interval estimate 204 to the new maintenance interval estimate 204 may be further constrained by the operating band 202. For example, if the newly-calculated maintenance interval estimate 204 would fall short of or exceed the bounds of the operating band 202, that maintenance interval estimate 204 would not be used in the following iteration of the process. In other instances, if the newly-calculated maintenance interval estimate 204 would exceed the maximum value 202b, the maintenance interval estimate 204 may assume the maximum value 202b. Likewise, if the newly-calculated maintenance interval estimate 204 would fall below the minimum value 202a, the maintenance interval estimate 204 may be set as the minimum value 202a.

If the elapsed usage 214 equals or exceeds the maintenance interval estimate 204, the notification 212 may be generated and communicated to an operator or other personnel associated with the equipment. That is, the notification 212 is generated and/communicated when a present elapsed usage 214 associated with the equipment equals or exceeds the maintenance interval estimate 204. The present elapsed usage 214 may be with respect to the previous time that the maintenance interval estimate 204 was calculated or the time that the equipment was replaced. The determination that the elapsed usage has exceeded the maintenance interval estimate 204 may be performed by an operator, whom may enter an indication thereof in a computer application of a computer system. This determination may additionally or alternatively be performed by the computer system. It is further noted that the elapsed usage 214 may be polled in real time or at less frequent intervals, which may be regular or irregular. A similar delay may occur in generating and/or transmitting the notification 212.

The notification 212 may indicate that the maintenance interval estimate 204 has been exceeded, thus informing an operator that the equipment may be at an increased risk of failure. The notification 212 further may comprise an identifier of the equipment, such as the make, model, and serial number of the equipment, as well as the location of the equipment. The notification 212 may indicate the maintenance interval estimate 204, the value of the elapsed usage 214 at the time at which the maintenance interval estimate 204 was exceeded, and a present value of the elapsed usage 214.

The notification 212 may be realized in several forms. For example, the notification 212 may be communicated to an operator or other personnel via email, text message, or automatic phone message. As another example, the notification 212 may be presented on a user interface of a computer application running on a computer system. The user interface may be implemented in the same computer application that is used to accept various user inputs or automated inputs, such as indications of equipment usage, incidents of equipment replacement, and reasons for replacement.

A notification 212 may be sent when the maintenance interval estimate 204 is initially exceeded. If the equipment is not replaced (or does not in fact fail), subsequent notifications 212 may be transmitted to an operator. The subsequent notifications 212 may occur at set intervals with respect to the usage metric, time, or other factor. The intervals between subsequent notifications 212 may incrementally decrease if the equipment is not replaced. That is, the operator is notified more often the longer the equipment goes un-replaced. In addition to more frequent notifications 212, the subsequent notifications 212 may be transmitted via other forms of communication. For example, initial notifications 212 may be transmitted via email while later notifications 212 may be transmitted via text message or automated phone call. The recipients of the notifications 212 may also escalate. For example, the notification 212 may be initially sent to a floor operator. Later notifications 212 may be instead transmitted to the operator's supervisor or manager. Subsequent notifications 212 may be sent according to the escalating elapsed usage 214 exceeding one or more thresholds. Those thresholds may represent certain percentage thresholds of the current elapsed usage 214 beyond the maintenance interval estimate 204 (e.g., every 20% of the maintenance interval estimate 204).

The adaptive preventative maintenance methods may also include a logging function with respect to any of the aspects described herein. For example, instances of the elapsed usage 214 exceeding the maintenance interval estimate 204 may be logged, including associated information such as the equipment identity, the time of the exceeding, and the particular elapsed usage 214. Instances of equipment replacement may also be logged, which again may include the identity of the equipment, the time of replacement, the reason for the replacement, and the value(s) of the relevant elapsed usage 214. Any notifications 212 generated and communicated may also be logged, including the time, means, and recipient(s) of the notifications 212, the identifiers of the associated equipment, the associated maintenance interval estimate 204, the value of the elapsed usage 214 at the time of exceeding the maintenance interval estimate 204, and the elapsed usage 214 at the time of the notification 212. Said logging may be implemented in a storage of a computer system, such as the computer system already mentioned above for operator interactions.

In an aspect, the disclosed adaptive preventative maintenance process and various embodiments thereof may utilize additional techniques to filter and/or smooth the data inputs used in determining and/or recalculating the maintenance interval estimate 204. For example, such techniques may be applied to the data input representing the elapsed usage 214 at the time of the most recent replacement of the equipment. As an example, the elapsed usage 214 input may be filtered in such a way as to afford less weight to more recent data points compared to data points preceding those more recent data points. For example, this data filtering may be given effect using one or more types of moving average analysis. Moving average analyses may include, for example, a simple moving average (SMA), a cumulative moving average (CMA), a weight moving average (WMA), and exponential weighted moving average (EWMA).

In an example technique to smooth and filter elapsed usage 214 input data used in determining or recalculating the maintenance interval estimate 204, the following equation may be implemented.

FILT_EL_USE=K*MI_EST+(1−K)*EL_USE

In this equation, EL_USE represents an elapsed usage 214 at the time of the most recent replacement of the equipment. MI_EST represents the current maintenance interval estimate 204 (i.e., before recalculation). K represents a value between 0 and 1, wherein a lower value of K will result in greater responsiveness while a higher value of K will result in less responsiveness. Finally, FILT_EL_USE represents an elapsed usage 214 that has been filtered. The filtered elapsed usage 214—rather than the actual elapsed usage 214 (EL_USE)—may then be used as an input in recalculating or determining a new maintenance interval estimate 204. In cumulative effect, multiple elapsed usages at the times of corresponding replacements may be filtered or smoothed to reduce the weight that would otherwise be given to aberrant or outlying elapsed usages (i.e., the “noise” in the input set of elapsed usages).

In another aspect, data from multiple separate installations of the equipment may be centrally collected by a third party and used to better understand the tolerances of the equipment. The separate installations may each use the same or similar equipment and under the same or similar operating conditions. The third party may analyze the maintenance interval estimates 204 independently determined for each installation and thereby determine an aggregate maintenance interval estimate 204 for the equipment. This aggregated maintenance interval estimate 204 may allow an equipment manufacturer to provide recommended maintenance or replacement schedules to customers, which they may not have been able to do previously.

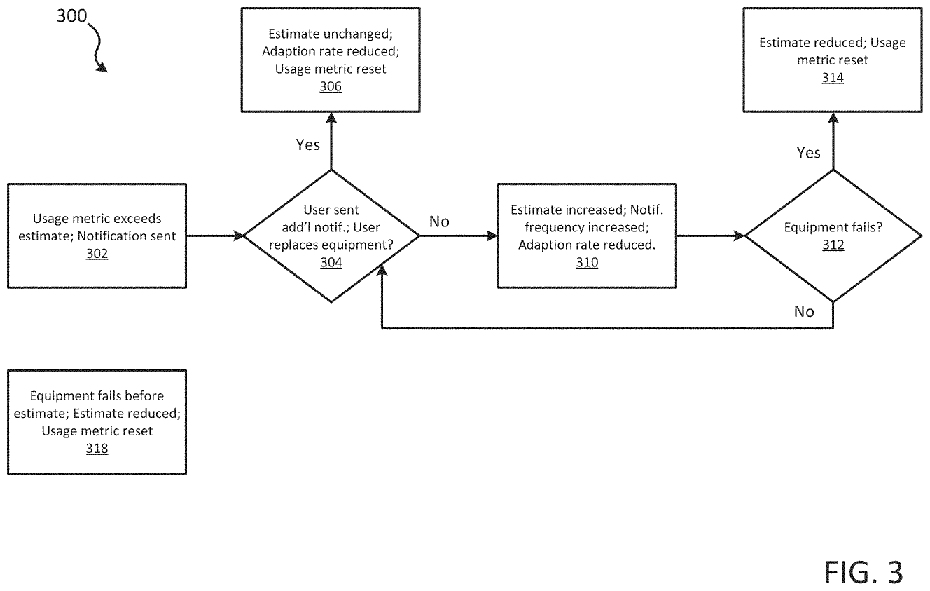

FIG. 3 illustrates a flow diagram 300 demonstrating a conditional flow of an embodiment of adaptive preventative maintenance. The embodiment illustrated in FIG. 3 may leverage the above-described techniques to filter and smooth input data by affording less weight to more recent data points and relatively more weight to earlier data points preceding the more recent data points. Example techniques may include a moving average such as a simple moving average (SMA), a cumulative moving average (CMA), a weight moving average (WMA), and exponential weighted moving average (EWMA).

The flow diagram 300 is discussed with respect to equipment, usage metrics, elapsed usages, maintenance interval estimates, notifications, etc., which are similar in some aspects to those described in relation to FIG. 2. Initially, at step 302, an elapsed usage (e.g., the elapsed usage 214 of FIG. 2) of a piece of equipment exceeds a maintenance interval estimate (e.g., the maintenance interval estimate 204 of FIG. 2). It will be recalled that an elapsed usage may be expressed in terms of a usage metric, such as an accumulated time of operation, a number of actuation cycles, or a number of substrates coated, as some examples. A notification (e.g., the notification 212 of FIG. 2) is sent to an operator or other personnel associated with the equipment to inform him or her that the maintenance interval estimate has been exceeded. As described above, the notification may be sent via email, text, or a user interface of a computer application.

It will be understood that, prior to step 302, the equipment has been in operation and the elapsed usage has been tracked or logged during this time or a portion of this time. Indeed, in step 318, the equipment fails before the associated elapsed usage even reaches the maintenance interval estimate. In this case, the maintenance interval estimate is reduced, such as in the manner described in relation to FIG. 2. The usage matric is subsequently reset. The equipment may have been replaced at this failure. Assuming so, the equipment may thereafter be returned to operation.

At step 304, the user is sent additional notifications to remind him or her that the maintenance interval estimate has been exceeded and the equipment has not yet been replaced. After sending the notification, it is determined if the operator has replaced the equipment, such as in response to the notification communicated in step 302 or step 304. If so, at step 306, the maintenance interval estimate remains unchanged. That is, this instant maintenance interval estimate is carried forward to a subsequent iteration of the process using the replaced equipment. Additionally, the adaption rate is reduced. The adaption rate may refer to the degree to which the instant elapsed usage at time of replacement and/or later elapsed usages are given weight in determining a new or recalculated maintenance interval estimate. For example, in the above described equation “FILT_EL_USE=K*MI_EST+(1−K)*EL_USE” the adaption rate is represented as “(1−K).” The elapsed usage is thereafter reset. The equipment may then return to operation.

If the operator did not replace the equipment at step 304, at step 310, the maintenance interval estimate is increased. The maintenance interval estimate increase may be based on the elapsed usage of the equipment at the time of the increase to the maintenance interval estimate or at another identified time. The adaption rate is further reduced. In addition, notifications continue to be sent to the operator, but the frequency at which they are subsequently sent is increased (i.e., the notifications are sent sooner than they would have been otherwise).

At step 312, it is determined if the equipment fails. If the equipment does not fail, the flow 300 returns to step 304 at which the user is sent additional notifications, except now at an increased frequency. If the equipment does fail, at step 314, the maintenance interval estimate is therefore reduced, which may be based on the elapsed usage at the time of failure (or subsequent replacement) and the fact that any replacement was due to the failure. As noted, the equipment may be replaced after the failure. The elapsed usage is reset and the equipment may be put back in operation. The notification frequency may also be increased.

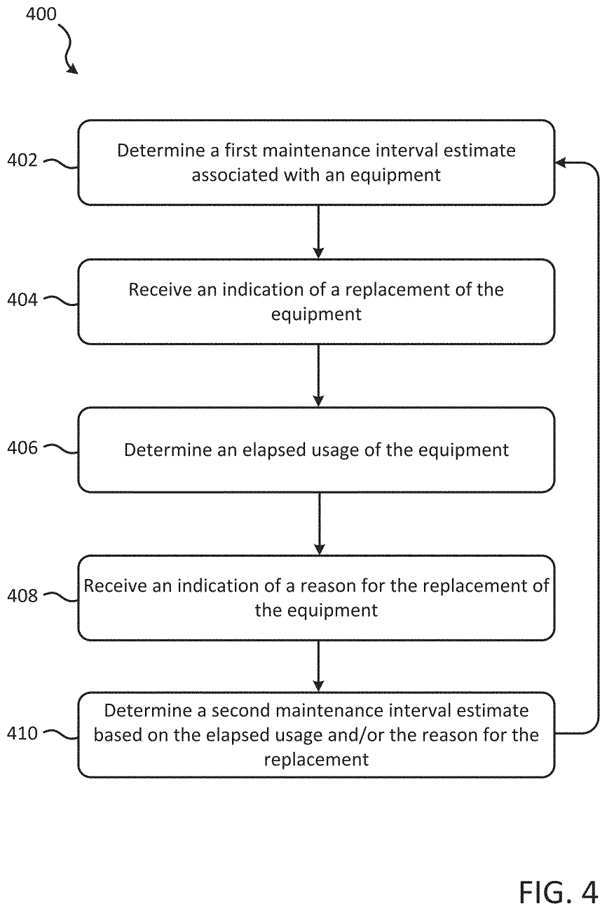

FIG. 4 illustrates a method 400 by which a maintenance interval estimate of equipment is determined and then refined over a number of iterations. In describing the method 400, reference will be made to maintenance interval estimates, equipment, usage metrics, notifications, equipment replacements, elapsed usages, etc., which are the same or similar to those described in relation to FIG. 2.

At step 402, a first maintenance interval estimate is determined. The first maintenance interval estimate may be associated with an equipment and may be expressed as a value of a usage metric associated with the equipment. As some examples, a usage metric may refer to a number of actuation cycles of a pump, an operating time of a heater, or a total time since installation of the equipment. If step 402 takes place in an initial iteration of the method 400, the first maintenance interval estimate may be a default value, such as that indicated by the equipment manufacturer. Alternatively, the first maintenance interval estimate may be the maintenance interval estimate that was determined in and carried forward from the previous iteration of the method 400 (e.g., the second maintenance interval estimate of step 410). A maintenance interval estimate may be confined to an operating band.

At step 404, an indication that the equipment has been replaced is received. The indication may be received via an automated process. For example, the equipment or a system of which the equipment is a part may be equipped with a sensor that indicates that the equipment has been replaced. In other instances, an operator may log the replacement. A computer may be used to receive the indication of the replacement, whether that is entered manually by the operator and received from a sensor.

At step 406, an elapsed usage of the equipment is determined and/or received. The elapsed usage may reflect the accumulated usage, in terms of a usage metric, of the equipment during a time period spanning from a reference time point associated with the first maintenance interval estimate and a later second time point associated with the replacement of the equipment.

In some instances the reference time point may be the time point at which the first maintenance interval estimate is determined. In other instances, the reference time point may be the time point at which the equipment was earlier replaced in a previous iteration of the method 400 or the time point at which the equipment entered service or commenced operation following its replacement in the previous iteration of the method 400.

The second time point may refer to the time at which the replacement referenced in step 404 was performed (or the indication of said replacement was received). This time point may be preferred if the equipment was replaced before failure. Alternatively, the second time point may refer to the time point at which the equipment failed and thus precipitated the replacement indicated in step 404. This time point may be appropriate when the equipment failed before being replaced.

As yet another alternative, the second time point may refer to the earlier of the time point at which the equipment failed or the time point at which the equipment was replaced. In one example, the reference time point may be the time at which the equipment first entered service or commenced operation and the second time point may be the time at which the equipment left service or ceased operation, regardless of whether it was due to failure or preventative replacement.

The elapsed usage may be determined by a computer system based on data collected directly from sensors or the like associated with the equipment or data entered by an operator. Alternatively, the elapsed usage may be entered into a computer system by the operator. Noting that the elapsed usage may be an estimate, in one example, an operator may calculate an estimate of the elapsed usage based on a number of days that the equipment has been in operation and an estimated number of daily actuation cycles, actions, use time, etc. This estimated elapsed usage may be entered into a computer system.

At step 408, an indication of a reason for the equipment replacement, referenced in step 404, is received and/or determined. In a contemplated use case, the reason for replacement may be either preventative or failure of the equipment. A decision to perform preventative replacement may be based on the equipment's elapsed usage and the maintenance interval estimate. For example, a preventative replacement may be responsive to the elapsed usage approaching, equaling, or exceeding the maintenance interval estimate. The reason for replacement is not limited to preventative or failure, but may include other reasons, such as a degradation in performance (e.g., a performance value falling outside of a threshold). The indication of the reason for replacement may be received by a computer system via an operator input to a user interface of a computer system.

At step 410, a second maintenance interval estimate is determined. The second maintenance interval estimate may be based on the equipment's elapsed usage (step 406) and the reason for the replacement (step 408) of the equipment. In some aspects, the second maintenance interval estimate may be based on the equipment's elapsed usage (step 406) without consideration to the reason for the replacement (step 408). The second maintenance interval estimate may be determined according to any of the techniques described herein, such as those described in relation to FIG. 2.

The second maintenance interval estimate, in most cases, is adjusted towards the elapsed usage. Using this empirical approach, a running maintenance interval estimate (embodied as the first and second maintenance interval estimate in this illustration) may be refined over multiple iterations to a theoretically ideal interval at which the equipment should be replaced.

The second maintenance interval estimate may also be determined according to an adjustment parameter (e.g., the adjustment parameter 216 of FIG. 2) which may affect whether and to what degree the second maintenance interval estimate is an adjustment towards the elapsed usage. The adjustment parameter may be user-defined, such as to control the degree of adjustment. In some aspects, the adjustment parameter may vary according to whether the equipment was replaced as preventative maintenance before failure (e.g., the preventative parameter 216a of FIG. 2) or due to failure (e.g., the failure parameter 216b of FIG. 2). A preventative replacement may tend to cause a lesser degree of adjustment between the first maintenance interval estimate and the second maintenance interval estimate than would be the case if the replacement was responsive to equipment failure.

At the conclusion of step 410, the second maintenance interval estimate may be carried forward in a further iteration of the method 400. Thus, in terms of the method 400 as illustrated, the first maintenance interval estimate of step 402 in the subsequent iteration may assume the value of the second maintenance interval estimate of the now-concluded iteration. Yet in some implementation, more akin to the representation shown in FIG. 2, a running maintenance interval estimate may simply be recalculated each time the equipment is replaced.

As described above in greater detail, if the elapsed usage equals or exceeds the maintenance interval estimate, a notification (e.g., the notification 212 of FIG. 2) may be transmitted to an operator or other relevant party. The notification may be sent, generally, at any time in the method 400. If the equipment is not subsequently replaced, additional notifications may be sent to a greater number of and/or different recipients, at shortened intervals between notifications, and/or via additional means of transmission.

The various steps may be performed in any practicable order, including concurrent performance. It will be particularly noted, however, that steps 406 and 408 may be performed in any order and/or concurrently with one or more of each other and step 404. For example, steps 404, 406, and 408 may be performed concurrently. As another example, steps 404 and 406 may be performed concurrently and step 408 may be performed thereafter. As another example, steps 404 and 408 may be performed concurrently while step 406 is performed afterwards. As yet another example, steps 404 may be performed initially and steps 406 and 408 may be performed concurrently thereafter.

The present methods and systems may be operational with numerous other general purpose or special purpose computing system environments or configurations. Examples of computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods disclosed herein may be implemented via a general-purpose computing device in the form of a computing device. The components of the computing device may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of determining a maintenance interval estimate for equipment, the method comprising:
providing a first maintenance interval estimate associated with the equipment, wherein the first maintenance interval estimate is expressed according to a usage metric associated with the equipment;
receiving an indication of a replacement of the equipment;
determining an elapsed usage of the equipment in a time period spanning from a reference time point associated with the first maintenance interval estimate to a later replacement time point associated with the replacement of the equipment; and
determining a second maintenance interval estimate based on the elapsed usage of the equipment, wherein the second maintenance interval estimate is expressed according to the usage metric associated with the equipment.

2. The method of claim 1, further comprising:
receiving an indication of a reason for the replacement of the equipment, wherein the second maintenance interval estimate is further based on the indication of the reason for the replacement of the equipment.

3. The method of claim 2, wherein the reason for the replacement is preventative, and wherein the second maintenance interval estimate is further based on a difference between the elapsed usage and the first maintenance interval estimate.

4. The method of claim 3, wherein the second maintenance interval estimate is further based on a user-defined adjustment parameter.

5. The method of claim 2, wherein the reason for the replacement is failure of the equipment, and wherein the second maintenance interval estimate is further based on a user-defined failure parameter.

6. The method of claim 5, wherein the second maintenance interval estimate is a multiplicative product of the user-defined failure parameter and the second maintenance interval estimate.

7. The method of claim 2, wherein the reason for the replacement is one of preventative or failure of the equipment, wherein:
if the reason for replacement is preventative, a difference between the second maintenance interval estimate and the first maintenance interval estimate is a first value,
if the reason for replacement is the failure of the equipment, the difference between the second maintenance interval estimate and the first maintenance interval estimate is a second value, and
the first value is less than the second value.

8. The method of claim 1, further comprising:
responsive to determining that the elapsed usage is greater than the first maintenance interval estimate, transmitting a notification to a user associated with the equipment.

9. The method of claim 1, further comprising:
determining that the second maintenance interval estimate is outside a pre-defined range of usage values defined by a lower usage value and an upper usage value; and
responsive to the determining that the second maintenance interval estimate is greater than the upper usage value, transmitting a notification to a user associated with the equipment.

10. The method of claim 1, further comprising:
responsive to determining the second maintenance interval estimate, receiving a second indication of a second replacement of the equipment;
determining a second elapsed usage of the equipment during a time period spanning from a second reference time point associated with the second maintenance interval estimate to a later second replacement time point associated with the second replacement of the equipment; and
determining a third maintenance interval estimate based on the second maintenance interval estimate and the second elapsed usage of the equipment, wherein the third maintenance interval estimate is expressed according to the usage metric associated with the equipment.

11. The method of claim 1, wherein the determining the second maintenance interval estimate is responsive to determining that a non-negative difference between the second maintenance interval estimate and the first maintenance interval estimate is greater than a drift value, and wherein the drift value is based on a pre-defined percentage of the first maintenance interval estimate.

12. The method of claim 1, wherein the usage metric comprises at least one of:
a time of operation;
a number of actuation cycles;
a number of operational cycles;
a number of objects; and
a quantity of material.

13. The method of claim 1, wherein the usage metrics comprises an aggregate usage metric based on a least two of:
a time of operation;
a number of actuation cycles;
a number of operational cycles;
a number of objects; and
a quantity of material.

14. The method of claim 1, wherein at least one of the indication of the replacement of the equipment and the indication of the reason for the replacement of the equipment is received via user input.

15. A method for effectuating notifications relating to maintenance of equipment, the method comprising:
determining that a first elapsed usage of the equipment exceeds a first maintenance interval estimate associated with the equipment, wherein the first maintenance interval estimate is expressed according to a usage metric associated with the equipment;
transmitting a first notification, indicating the first elapsed usage exceeding the first maintenance interval estimate, to a user associated with the equipment, wherein the first elapsed usage spans a first time period beginning at a first time point associated with the first maintenance interval estimate and ending at a second time point associated with the determining that the first elapsed usage of the equipment exceeds the first maintenance interval estimate; and
determining a failure to replace the equipment; and
transmitting a second notification, associated with the failure to replace the equipment, to the user associated with the equipment.

16. The method of claim 15, further comprising:
receiving an indication of a replacement of the equipment; and
determining a second maintenance interval estimate based on a second elapsed usage of the equipment in a second time period spanning from the first time point associated with the first maintenance interval estimate to a later third time point associated with the replacement of the equipment, and wherein the second maintenance interval estimate is expressed according to the usage metric associated with the equipment.

17. The method of claim 15, further comprising:
determining a second failure to replace the equipment; and
transmitting a third notification, associated with the second failure to replace the equipment, to the user associated with the equipment, wherein the time interval between transmitting the second notification and transmitting the third notification is greater than the time interval between transmitting the first notification and transmitting the second notification.

18. The method of claim 17, wherein a transmission medium of the third notification is different than a transmission medium of at least one of the first notification and the second notification.

19. The method of claim 17, wherein the third notification is transmitted to an additional user over recipients of at least one of the first notification and the second notification.

20. The method of claim 17, further comprising:
determining a third failure to replace the equipment; and
transmitting a fourth notification, associated with the third failure to replace the equipment, to the user associated with the equipment, wherein the time interval between transmitting the third notification and transmitting the fourth notification is greater than the time interval between transmitting the first notification and transmitting the second notification.
